(19) United States
(12) Patent Application Publication
(10) Pub. No.: US 2010/0237215 A1
(43) Pub. Date: Sep. 23, 2010

(54) PATIENT SUPPORT

(76) Inventor: Glenn Dahl, Las Vegas, NV (US)

Correspondence Address: LAW OFFICE OF MARK WISNOSKY, 3200 Fourth Avenue, Suite 203, SAN DIEGO, CA, 92103, US

(21) Appl. No.: 12/407,422

(22) Filed: Mar. 19, 2009

(51) Int. Cl. F16M 11/24; A47C 20/00; A61G 5/10; F16M 13/00; A61G 7/065; A61G 7/05

(52) U.S. Cl. 248/419; 5/632; 280/304.1

(57) ABSTRACT

A patient support system is described. The patient support enables a weakened or injured patient to support themselves in an upright position. Sitting in an upright position often provides the bed-ridden patient relief from pain, helps circulation and improves breathing. Embodiments are described that may be used with hospital equipment, wheel chairs as well as home furnishings such as conventional beds and chairs. The patient support position relative to the patient is adjustable through placement and may be fine tuned through embodiments including vertical and tilt adjustments built into the attachment means.

### BACKGROUND OF THE INVENTION

1. Technical Field

The present invention relates to a support system to allow injured and weakened patients to maintain an upright position for comfort and health reasons.

2. Related Background Art

Patients in a weakened condition due to illness or injury frequently are unable to support themselves for extended periods in an upright position. A long-term prone position can result in breathing difficulties, development of pneumonia and development of bedsores on the back and head. These conditions can be alleviated if the patient is able to change positions and in particular can sit upright.

Previous aids for debilitated patients have been in the form of specialty hospital equipment such as stirrups and supports for patients with broken limbs or patients in special cast systems such as a spica body cast. These systems are often available just in a hospital setting or at the patients' homes only at great expense. No system is known that can easily be used in conjunction with the existing beds and chairs typically found at the patients home. Custom modifications of furniture or even providing hospital like furnishings in the home are often required. Home use support systems such as walkers have been adapted with seats but do not provide the support required for a longer term positioning. The seats do not provide the comfort of the patient's favorite easy chair while at the same time providing a means to support the patients' torso in an upright seated position.

There is therefore a need for a support system for the weak or debilitated patient. There is a need for an inexpensive system that can be adapted for use with current home and hospital furnishings.

### DISCLOSURE OF THE INVENTION

A support system for the debilitated patient is described. The system consists of an adjustable horizontal bar on which the patient can lean their head, arms and torso to support themselves in an upright position. The bar may be padded for comfort and is adjustable in vertical, horizontal and a tilting direction. The support is movable either through moving the frame or through use of built in pivots to allow the support to be moved out of the way for entrance and exit of the bed or chair and for otherwise access to the patient.

One embodiment includes support framework for attachment to existing hospital equipment such as hospital beds and wheel chairs. Clamps are provided that attach to the common frames and side bars of either a bed or wheel chair. The clamps provide for adjustable positioning of the support and allow the height and angle of the support to be easily changed. The clamps may further include pivots to allow the support to be swung away from the patient for either access to the patient or for entrance and exit from the chair or bed. Another embodiment is freestanding. It requires no attachment to the bed or chair and therefore allows use with both hospital furnishings and conventional beds or chairs found in the home. Additional embodiments may be used with wheel chairs. The support may be clamped to the frame of the wheel chair. Embodiments include adjustments along multiple axes for fit and comfort. Another embodiment includes a pivot in the attachment so that the support may be swung out of the way for entrance and egress from the chair and for easy access to the patient. Other embodiments are freestanding and may be used with multiple seating arrangements.

### BRIEF DESCRIPTION OF THE DRAWINGS

FIG. 1 is a view of a wheelchair embodiment showing use by a patient.

FIG. 2 is a view of a wheel chair embodiment showing a pivot embodiment of the invention.

FIG. 3 is an exploded view showing component parts of an embodiment.

FIG. 4 is a view showing an embodiment in use with a bed.

FIG. 5 is a view showing component parts of an embodiment.

FIG. 6 is a close up view of the attachment portion of the embodiment shown in FIG. 5.

### MODES FOR CARRYING OUT THE INVENTION

There are several modes for carrying out this invention. A common feature of all modes is a support bar positioned in front of the patient upon which he can rest his head, arms and/or torso to maintain a comfortable upright position even when weakened. Embodiments provide various means to mount the support bar or attach it to furniture such as a bed or chair for use.

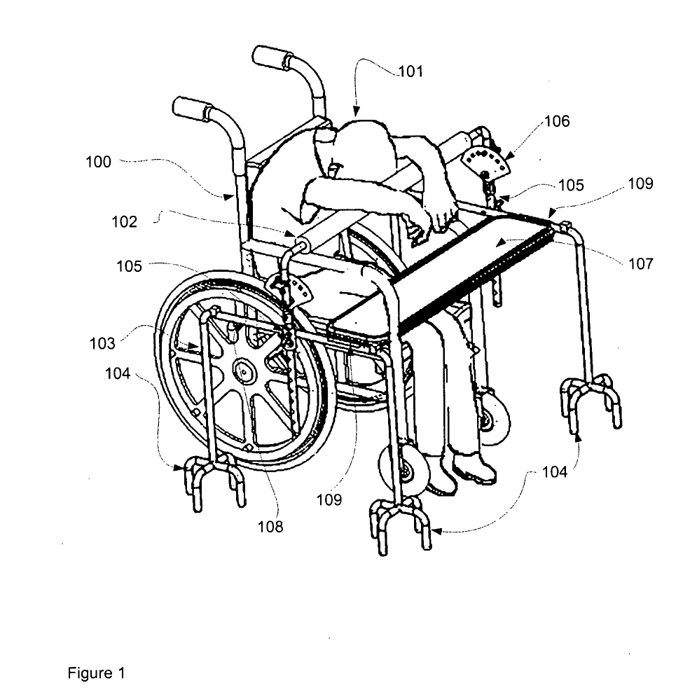

Referring to FIG. 1, a patient 101 is seen in a wheel chair 100. The support bar 102 is seen to provide support for the patient's 101 head and arms. The support bar is attached to a freestanding support structure consisting of feet 104 and support structure 103, 108 that allows the patient support to be used with no modification or attachment to the wheel chair. The support structure consists of vertical members 103 and horizontal members 108 attached to feet 104. One support structure is seen on either side of the chair 100. The patient support bar 102 is attached to the free-standing structure 103, 104, 108 through a means 105 that allows vertical adjustment of the location of the patient support bar 102. Also shown is a means 106 for tilting the support bar 102 in a direction towards and away from the patient. The combination of the vertical adjustment 108 and the tilting adjustment 106 as well as the ability to place the support structure 103, 104, 108 relative to the chair 100 provides a means to optimize position of the patient support bar 102 with respect to the patient 101. Also shown is an exemplary accessory attachment to the support structure. In this case a table 107 is attached across the horizontal support bars 108 thus providing a surface for holding for example food or reading material in front of and within reach of the patient. The table surface 107 rests upon the horizontal support bars 108 through curved attachment means 109 that match the radius of curvature of the horizontal support bars 108.

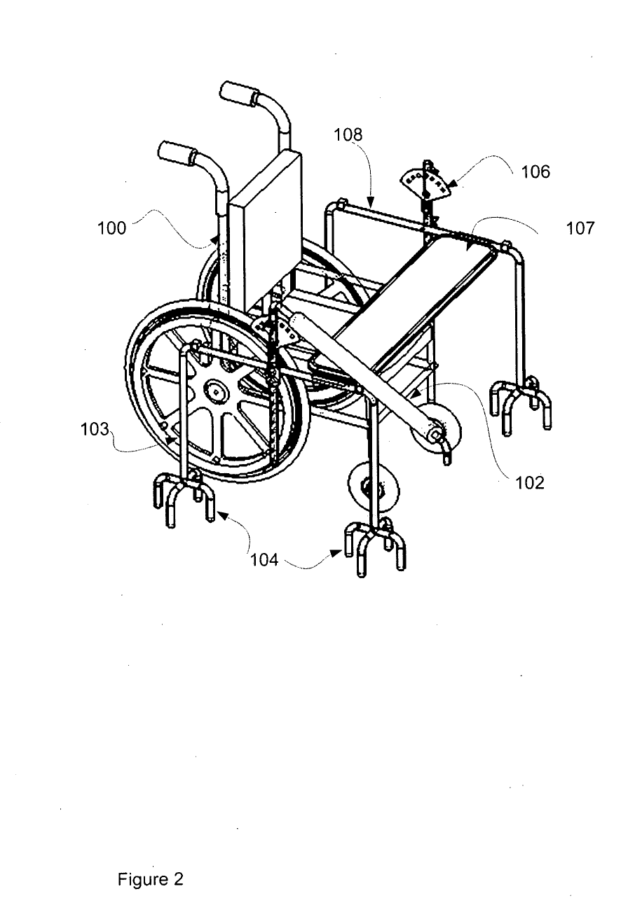

Referring to FIG. 2, the same embodiment as seen in FIG. 1 is shown without the patient for a clearer view of the mechanics of the patient support. FIG. 2 also shows the means through the attachment 106 to swing the patient support bar 102 away from in front of the patient. The embodiment shown allows easy ingress and egress of a patient from the chair through swinging the patient support bar out of the way and lifting tray 107 from the horizontal support bars 108 of the frame. Neither the patient support bar 102 nor the tray 107 are required to support the frames on either side as they are freestanding by virtue of the feet 104.

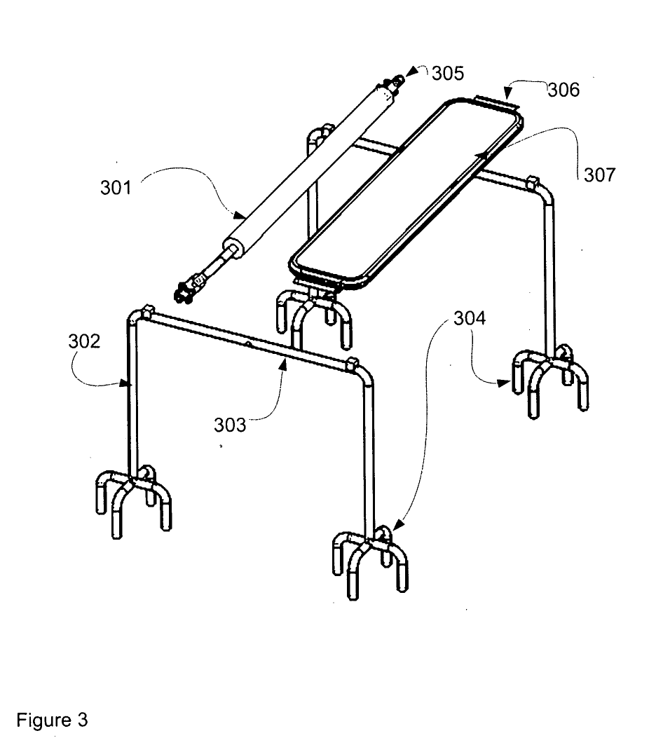

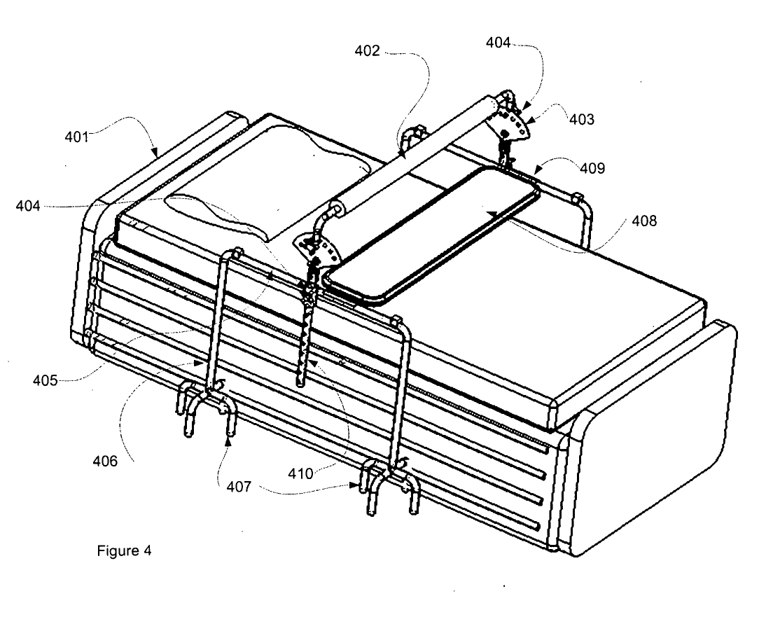

FIG. 3 shows components of embodiments of the invention without the wheel chair of previous figures. The patient support bar 301 attaches to a support frame 302, 303, 304 through a clamping means 305. The support frame consists of a horizontal bar 303 supported by two vertical bars 302. Each vertical bar fitted with feet 304 at the lower end that allows the support frame to be freestanding. The embodiment uses two support frames in use, one positioned on either side of the patient seating means. Exemplary seating means includes but is not limited to the wheel chair as shown in FIGS. 1 and 2. The embodiments may also be used in conjunction with a bed as shown in the example of FIG. 4. The embodiment optionally further includes an accessory such as a table top 307 which may rest upon the horizontal support bars of the frame 303 through mounting means 306. Note that in this embodiment the patient support bar attaches directly to the support frame without the tilting or height adjustment means shown in previous figures.

FIG. 4 shows an embodiment of the invention used in conjunction with a bed. The patient support bar 402 is positioned above a bed 401. Exemplary beds include a typical bed as used in the home and a hospital bed. The patient support bar 402 is removably attached to a tilting means 403 through a screw-tightened fitment 404. The embodiment further includes a means to adjust the vertical height of the patient support bar with an adjustably positioned vertical support 410. The patient support bar is positioned across the bed by attachment to a pair of support frames 405, 406, 407. The support frames similar to previous embodiments consist of a horizontal support bar 405 supported at either end by vertical support bars 406. The lower ends of the vertical support bars are attached to supporting feet 407, thereby providing a freestanding frame. A pair of frames is used in practice, one on either side of the bed. In another embodiment, not shown, the patient support bar may be attached directly to the bed rails of, for example a hospital bed, fitted with side rails on either side of the bed and patient. In another embodiment not shown the patient support bar may be swung away from the patient to allow easy ingress and egress from the bed. This embodiment is very similar to that depicted in FIG. 2 for the patient support system used in conjunction with a chair.

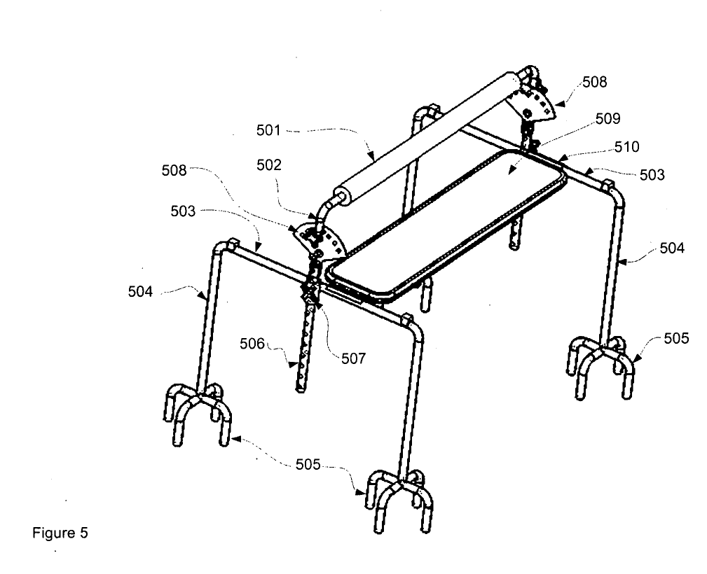

FIG. 5 shows an embodiment of the invention that may be used with for example either a bed or a chair. The embodiment is scaled in size for the appropriate furniture with which it will be used. That is, a version of the embodiment for use with a chair would be smaller than a version of the embodiment for use with abed. The embodiment consists of a patient support rail 501 that is positioned in front of the patient to allow support of the patients' head, arms and torso. The patient support bar as shown is padded with for example a foam piece surrounding the rigid support bar. The embodiment further comprises a right angle piece 502 attached to the patient support bar 501. The angled piece 502 is attached to a support means 508 through a fitting 511 that allows for rotation in the horizontal plane so that the patient support bar may be swung out of the way for ingress and egress. The support means 508 further allows for adjustment of the angle of the support bar 501 for fine-tuning of height and position in front of the patient. The angle adjustment means 508 is further attached to a vertical adjustment bar 506 that attaches to a horizontal frame support bar 503 through a clamping means 507. The vertical bar 506 may be adjusted vertically through use of a clamping means 507. The horizontal frame support bar 503 is attached to vertical legs 504 and then to feet 505 that allow the frame to be freestanding. An equivalent support frame 503, 504, 505 is placed on either side of the patient to support either end of the patient support bar 501. The embodiment further optionally includes a tray 509 that is fitted to attachment means 510 that fit onto the horizontal frame support bars 503.

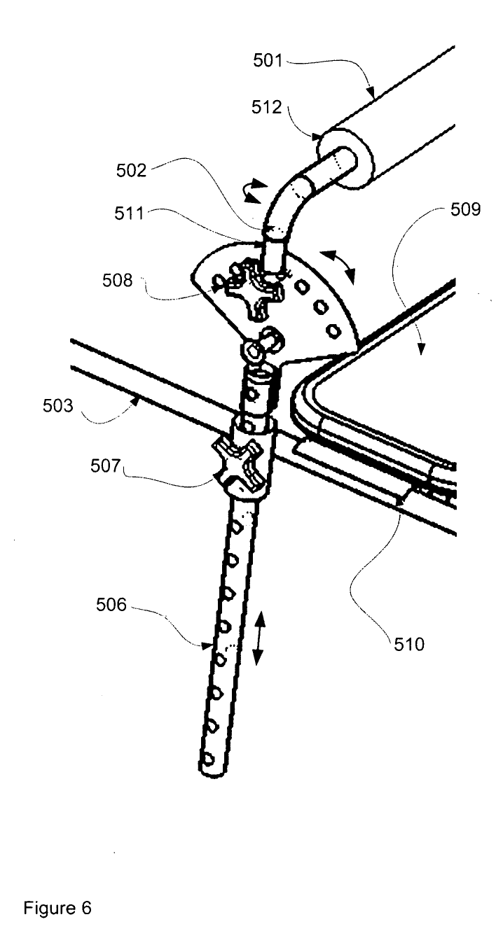

FIG. 6 shows a close-up view of the attachment point of the embodiment of FIG. 5. The patient support bar 501 is optionally padded with for example foam padding 512. The patient support bar 501 is fitted to a right angle piece 502 that further fits to an attachment means 511. The attachment means 511 allows rotation of the patient support bar in the horizontal plane if the opposite end of the patient support bar is detached. The end opposite the attachment of the patient support bar of the attachment means 502 is attached at to an attachment means 508 that allows for the aforementioned rotation and is further attached to a means 508 that allows for adjustment of the position of the patient support bar through a tilting motion as shown. The adjustable attachment means 508 is further attached to a vertical support bar 506 that fits through a clamping means 507. The vertical support bar and the clamping means allows for adjustment of the patient support bar in the vertical direction as shown. The clamping means 507 is further attached to a horizontal frame support bar 503 that is fitted to vertical support bars, not shown in this view, and the remainder of the support frame as discussed above. In another embodiment the horizontal frame support bar 503 are bed rails as are often found on the sides of hospital beds. In another embodiment the horizontal frame support bars 503 are the arms found on a wheel chair. In another embodiment the horizontal frame support bars 503 are the arms of a conventional chair with tubular arms. Also shown in FIG. 6 are portions of an optional tray 509 that may be attached to the horizontal frame support bars 503 with an attachment means 510. The attachment means 510 is preferable shaped to mate with the shape of the horizontal frame support bars 503.

### SUMMARY

A patient support system is described. The patient support enables a weakened or injured patient to support himself or herself in an upright position. Sitting in an upright position often provides the bed-ridden patient relief from pain, helps circulation and improves breathing. Embodiments are described that may be used with hospital equipment, wheel chairs as well as home furnishings such as conventional beds and chairs. The patient support position relative to the patient is adjustable through placement and may be fine tuned through embodiments including vertical and tilt adjustments built into the attachment means.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. A patient support comprising:
a) a horizontal bar positioned in front of the patient in such a position as may be used by the patient to support said patient's head, arms and torso, and
b) a support frame for said horizontal bar comprising attachment points at each end of said horizontal bar.

2. The patient support of claim 1 where the support frame includes means to adjust the horizontal bar in the vertical direction.

3. The patient support of claim 1 where the support frame includes means to tilt the horizontal bar towards or away from the patient.

4. The patient support of claim 1 where the support frame is freestanding.

5. The patient support of claim 1 further including a tray attached to the support frame and located in front of the patient.

6. The patient support of claim 1 where the support frame further includes means to rotate the horizontal bar in the horizontal plane about at least one of said attachment points.

7. The patient support of claim 1 where:
a) the support frame includes means to adjust the horizontal bar in the vertical direction, and
b) the support frame includes means to tilt the horizontal bar towards or away from the patient, and
c) the support frame is freestanding, and
d) the support frame further includes means to rotate the horizontal bar in the horizontal plane about at least one of said attachment points.

8. The patient support of claim 1 where the support frame is attached to the rails of a hospital bed.

9. The patient support of claim 8 where:
a) the support frame includes means to adjust the horizontal bar in the vertical direction, and
b) the support frame includes means to tilt the horizontal bar towards or away from the patient, and the support frame further includes means to rotate the horizontal bar in the horizontal plane about at least one of said attachment points.

10. The patient support of claim 1 where the support frame is attached to the arms of a wheel chair.

11. The patient support of claim 10 where:
a) the support frame includes means to adjust the horizontal bar in the vertical direction, and
b) the support frame includes means to tilt the horizontal bar towards or away from the patient, and the support frame further includes means to rotate the horizontal bar in the horizontal plane about at least one of said attachment points.
